(19) United States
(12) Patent Application Publication
(10) Pub. No.: US 2025/0131100 A1
(43) Pub. Date: Apr. 24, 2025

(54) SYSTEM AND METHOD FOR SAAS DATA CONTROL PLATFORM

(71) Applicant: ROYAL BANK OF CANADA, Toronto (CA)

(72) Inventors: Salah SHARIEH, Toronto (CA); Fatima Javaid HUSSAIN, Toronto (CA); Evgenii OSTANIN, Toronto (CA); Brett NOYE, Toronto (CA); Paula DUZI, Toronto (CA); Haoyue BAI, Toronto (CA); Nebojsa DJOSIC, Toronto (CA)

(73) Assignee: ROYAL BANK OF CANADA, Toronto (CA)

(21) Appl. No.: 18/920,875

(22) Filed: Oct. 19, 2024

Related U.S. Application Data
(60) Provisional application No. 63/591,549, filed on Oct. 19, 2023.
(60) Provisional application No. 63/591,560, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.
(60) Provisional application No. 63/655,183, filed on Jun. 3, 2024.

(51) Int. Cl. G06F 21/57

(52) U.S. Cl. CPC G06F 21/577; G06F 2221/033

(57) ABSTRACT

There is provided a system for compliance monitoring of applications executing in cloud operating environments. The system may convert rule-containing documents to tree structures comprising nodes representing compliance rules. The system may monitor controls which provide evidence of applications' compliance when triggered by events, such as configuration changes and user interactions. The compliance evidence may be evaluated for an effect on an application's compliance score. The system may further provide a unique mapping identifier system for mappings between tree structures, controls, and compliance evidence. The system may further include a layered anomaly detection module which include a real-time processing component and a second processing component for generating and refining anomaly detection machine learning models which is de-coupled from the real-time processing component. The system may further include a compliance and risk prediction module configured to account for partial compliance evidence data with predicted compliance evidence data for missing components.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655,183, filed Jun. 3, 2024, the entire contents of each of the above-identified applications being incorporated herein by reference.

### FIELD

This relates generally to automated compliance systems for use with software applications.

### BACKGROUND

The use of computerized systems and software has become ubiquitous throughout organizations. In many organizations, the use of third-party Software-as-a-Service (SaaS) applications (i.e. SaaS applications which are created and administered outside of the organizing using the SaaS) is becoming increasingly common, as modern communications systems have overcome bandwidth limitations which might have limited the utility of such SaaS applications in the past. Moreover, an increasing number of vendors have shifted to only offering SaaS distribution models.

However, there are several challenges inherent with the use of third party SaaS applications for organizations. For example, an organization may be subject to regulations and/or compliance requirements to which the organization is required to adhere. When computer and/or software systems are developed and implemented within an organization, such systems may be tailored to the specific regulations and/or compliance requirements to which the organization is bound. However, third party SaaS applications may not have been developed with a particular set of regulations or compliance requirements in mind, particularly given that compliance requirements might vary from customer to customer, and as such there might not be a uniform set of standards for to which a particular SaaS application must adhere.

For many organizations, adherence to regulatory and compliance requirements is of paramount importance and ensuring that any proposed new SaaS is compliant with regulations and/or compliance requirements may be a time-consuming and onerous task, which may prevent, impede or retard the adoption of improved technologies and services. Moreover, ensuring that an existing SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

Accordingly, there is a need for a computing system which does one or more of streamlining the process of determining whether an application will comply or is compliant with relevant requirements, converting such requirements to a form understandable by computing devices suitable for automation, automatically monitoring for potential compliance issues, automatically monitoring for anomalous behaviours from applications, and provides predictive protection against potential future events.

### SUMMARY

According to an aspect, there is provided a system for automated compliance monitoring and risk detection for applications executing in a distributed operating environment, the system comprising: an automated mapping and tree structure generation module configured to automatically convert rule-containing documents to tree data structures comprising nodes representing compliance rules, and automatically update said tree data structures when any of said underlying rule-containing documents are modified; a compliance mapping system configured to separate technical and domain expertise and provide mappings between said tree data structures, controls which monitor applications for compliance with compliance rules, and generate compliance evidence when an event triggers the control; a layered anomaly detection system configured to detect anomalous behaviour from said application, said anomaly detection system comprising a real-time processing component and a second processing component de-coupled from said real-time processing component, said second processing component configured to generate and refine anomaly detection machine learning models, said real-time processing component configured to detect anomalous behavior in real-time using said anomaly detection machine learning models; and a compliance and risk prediction system configured to account for partial compliance evidence by generating predicted partial compliance evidence data for missing components of said compliance controls.

According to another aspect, there is provided a method of compliance monitoring and risk detection for applications executing in a distributed operating environment, the method comprising: converting rule-containing documents to tree data structures comprising nodes representing compliance rules; providing mappings between said tree data structures; providing controls which monitor applications for compliance with compliance rules; generating compliance evidence when an event triggers at least one of said controls; detecting anomalous behaviour from said application using a real-time processing component and a second processing component de-coupled from said real-time processing component; and generating predicted partial compliance evidence data for missing components of said compliance controls.

According to still another aspect, there is provided a non-transitory computer-readable storage medium having stored thereon processor-executable instructions that, when executed by one or more processors, cause the one or more processors to perform a method comprising: converting rule-containing documents to tree data structures comprising nodes representing compliance rules; providing mappings between said tree data structures; providing controls which monitor applications for compliance with compliance rules; generating compliance evidence when an event triggers at least one of said controls; detecting anomalous behaviour from said application using a real-time processing component and a second processing component de-coupled from said real-time processing component; and generating predicted partial compliance evidence data for missing components of said compliance controls

Other features will become apparent from the drawings in conjunction with the following description.

### BRIEF DESCRIPTION OF DRAWINGS

In the figures which illustrate example embodiments,

FIG. 1 is a block diagram depicting components of an example multi-tenant operating environment;

FIG. 2 is a block diagram depicting components of an example computing device;

FIG. 3 depicts a simplified arrangement of software at computing device;

FIG. 4 is a block diagram depicting example components of a compliance system.

### DETAILED DESCRIPTION

At present a given organization may use dozens or even hundreds of Software-as-a-Service (SaaS) solutions across various lines of business, and which have varying degrees of complexity (e.g. some may use confidential data, others may use sensitive data, still others may use restricted data, and the like). Such SaaS applications may be executing on different cloud platforms, although many SaaS applications may be concentrated within a few large cloud providers (e.g. AWS).

When an organization decides whether to make use of a new SaaS solution, an organization must determine whether the SaaS solution is compliant with regulatory and compliance requirements, and this may be difficult to determine in an expedient manner. In particular, there are many different approaches to assessing regulatory compliance and risk (e.g. Supplier Risk Management Assessments (SRMA), Shared SaaS Responsibility Assessments (SSRA), Supplier Controls Assessments (SCA), and the like), many of which are questionnaire-based and require inputs from both users and suppliers to make an assessment. Completion of such assessments can be quite time-consuming, which limits the ability for SaaS solutions to be adopted in a timely manner, and which may pose significant inconvenience internally within an organization.

As described herein, some embodiments may provide data-driven automation for SaaS applications which facilitates processing of compliance evidences and continuous real-time risk assessment. Some embodiments may facilitate automation of onboarding processes for SaaS applications to ensure that a SaaS application is compliant from the beginning, and/or to reduce the amount of time required to certify a SaaS application as compliant. Some embodiments may allow for automation of compliance assessments for SaaS applications which run on computing platforms which are external to an organization's network (e.g. SaaS applications running on public and/or third-party cloud computing platforms, such as Amazon Web Services (AWS)). In some embodiments, systems disclosed herein may facilitate identification of dependences and patterns which exist between a plurality of SaaS applications (e.g. dependencies which may exist between SaaS applications relating to customer relationship management, business process management, human resource management, and the like).

In some embodiments, systems and methods disclosed herein may allow for one or more of: SaaS applications being adopted and onboarded faster than traditional methods, resulting in reduction of the time required to implement a new SaaS application, a reduction in the cost of onboarding an SaaS application, a reduction in the costs associated with regulatory compliance for a given SaaS application, a reduction in the cost of governance and management associated with a given SaaS application, real-time access to risk and compliance data relating to an SaaS, more accurate risk and compliance data, the ability to demonstrate alignment/compliance with regulatory requirements, and/or the ability to more quickly recognize which SaaS applications require further attention and/or scrutiny.

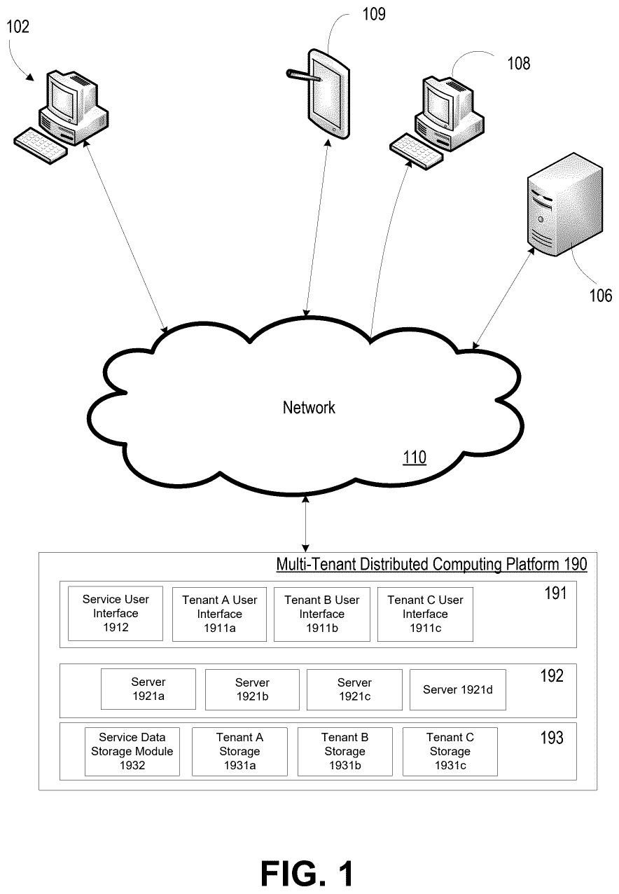

Various embodiments of the present invention may make use of interconnected computer networks and components. FIG. 1 is a block diagram depicting components of an example multi-tenant operating environment. Components of the computing system are interconnected to define a compliance and risk assessment system. As used herein, the term “compliance and risk assessment system” refers to a combination of hardware devices configured under control of software and interconnections between such devices and software. Such systems may be operated by one or more users or operated autonomously or semi-autonomously once initialized.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 104 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1.

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g. service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g. Amazon, Microsoft, Google, or the like) to provide multiple tenants with applications, data storage, and functionality. A multi-tenant system as depicted in FIG. 1 may include multiple different applications (e.g. multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

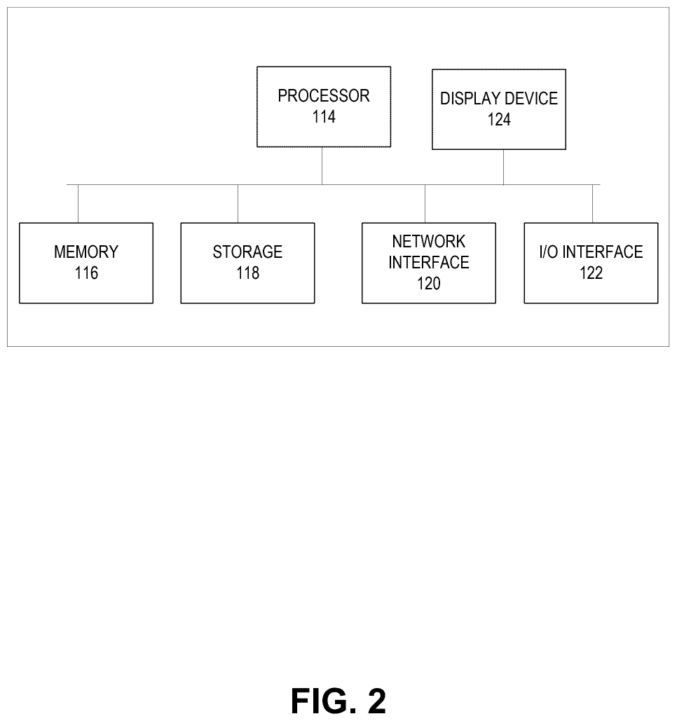

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third-party SaaS applications (e.g. SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

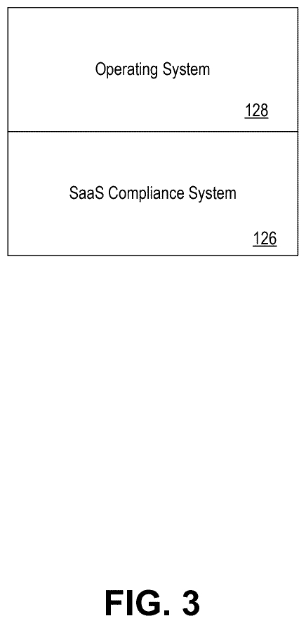

FIG. 3 depicts a simplified arrangement of software at an example computing device. The software may include an operating system 128 and application software, such as SaaS compliance system 126. It will be appreciated that in distributed computing environments, implementation and administration of an application such as a SaaS application or a SaaS compliance system 126 may be distributed amongst a plurality of separate computing devices, and FIG. 3 is intended to depict a simplified logical separation between an operating system and an application executing thereon on an example computing device.

Various embodiments of the systems and methods disclosed herein may present numerous advantages over existing systems. For example, some embodiments may deliver compliance evidence processing and continuous risk assessment in real-time for an application (including, but not limited to, a SaaS). Some embodiments may automate some or all onboarding activities for new software applications by ensuring compliance as a default from the start, and reduce the time required to certify a new application. Some embodiments may automate compliance within the data domain, the security domain, and the operational excellence domain. Some embodiments may automate dependency discovery, for example by identifying hidden dependencies and patterns across various applications and platforms.

Advantageously, some embodiments may readily support audits and regulation, as compliance evidence collection is automated and stored, thereby making it easier and more transparent to assess whether policies, procedures and activities (referred to herein as controls) are operating effectively. Some embodiments may further offer pre-built frameworks and collections of controls with descriptions and testing procedures. Such controls may be groups according to a specific compliance standard or regulation requirement, and mappings may be provided between standards and regulation requirements.

Existing solutions to compliance tend to be a black-box model with predetermined, monolithic processing model based on implied assumptions and complex implementations, and difficult to integrate and maintain. It is common for organizations to have to change processing practices to accommodate minor changes, or pay for customizations and integrations to maintain existing systems. To process end-to-end governance flows, existing products end up as monolithic from a usage perspective. For example, existing systems which monitor a specific third-party software provider must be on-boarded and processed through a system, which requires the organization to adopt the product's methods of on-boarding and migrate existing data into the product.

Contrastingly, some embodiments of system 100 do not depend on any end-to-end workflow and do not require data migration because, for example, machine learning models used for real-time processing are trained independently and de-coupled from actual real-time processing. Moreover, tasks such as population classification may be implemented as separate layers, separate subsystems, and may be based on features or attributes found in the data itself. As such, some embodiments of system 100 may obviate the need to import data (e.g. a whole HR user set) for system 100 to analyze and understand the data set. Since the same approach is used at run-time, this layered approach with parallel running of ML algorithms allows different models to process different data formats, or process different formats in different ways.

System 100 may also reduce the amount of user training required in order for users to understand a large number of complex configurations. Training typically requires technical knowledge and domain experts, which must be hired, whereas embodiments described here incorporate mappings which separate technical and domain expertise while enabling automation.

Moreover, the parallel processing approach at run-time may allow for adding, removing, and changing various models and underlying schemas without affecting operation of the system.

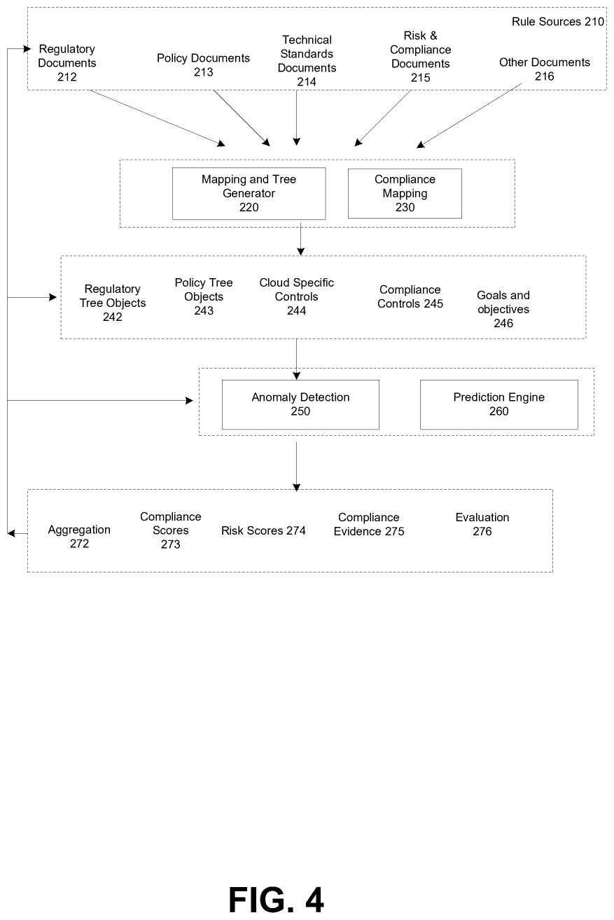

FIG. 4 is a flow chart depicting example components of a compliance and risk assessment system, in accordance with some embodiments. As depicted, system 100 includes rules sources 210 which are provided to Mapping and Tree Generator 220. In some embodiments, rules sources 210 may include, but are not limited to, regulatory documents 212, policy documents 213, technical standards documents 214, risk and compliance documents 215, and other documents 216. As such, rules sources 210 may include documents which are created at one or more of the industry, government and/or regulators, corporate, as well as team levels.

Rules sources 210 can be conceptualized generally as unstructured texts which contain a variety of rules and constraints. Moreover, different rules sources (e.g. technical standards documents vs. regulatory documents) are typically created by teams of experts within distinct domains and may not use similar terminology. Although rules sources 210 may contain numerous interrelated or overlapping rules and regulations which an organization may be required to follow, the contents of such rules sources 210 is not easily read or understood by a computing device, and relationships and/or commonalities between such documents would not be apparent or ascertainable. As such, the process of determining whether a particular SaaS product is compliant with all of the relevant requirements is particularly difficult and time-consuming.

Moreover, in the event that relationships between rules sources 210 are determined (e.g. by a team of experts from disparate domains), such relationships may only be true as long as each of the relevant rules sources 210 remain unchanged. It is possible that an amendment to one rule source 210 (e.g. an amendment to a regulatory document 212 or technical standards document 214) may result in all of the previously identified interrelationships being rendered invalid, and as such may require continuous expenditure of effort from experts to verify.

Typically, combinations of such rules sources 210 is used as a source of requirements for an organization when implementing or considering implementation of a software application (e.g. a SaaS application). As such, determining whether that particular SaaS application is compliant with all of the relevant rules sources 210 is a significant and time-consuming undertaking, requiring the involvement of numerous subject matter experts each step of the way.

Moreover, applications currently available tend to require significant training for users to ensure compliance, as well as customized configurations which must be prepared, implemented, and tested prior to production deployment, which entails further pilot runs and migrations during production. The execution of an application will product evidence which may then be used to assess compliance with the relevant rules 210. Frequently, even minor changes to requirements may lead to significant complications and render the comparison of compliance evidence from before and after the change difficult, as data may become incompatible or inappropriate to compare.

In some embodiments, system 126 may allow for the additional, removal, and/or modification of rule sources 210 while maintaining a coherent mapping between compliance evidence obtained before and after such addition, removal and/or modification.

As depicted, one or more rules sources 210 may be provided to Mapping and Tree Generator (MTG) 220. In some embodiments, MTG 220 may process human-readable documents and convert such documents into formats suitable for automation and processing using computer hardware and software-based systems. An example implementation of an automatic mapping and tree generation system is provided in U.S. Provisional Patent Application No. 63/591,646, filed on Oct. 19, 2023, Attorney Docket Number 05007268-345USPR, the contents of which are incorporated herein by reference.

In some embodiments, one or more prompts may be used to generate tree structures 242, 243 based on said rule-containing sources 210. In some embodiments, a prompt is an object containing a set of instructions and/or guidelines to the model in order to steer a specific reasoning or form to the output.

Such tree structures 242, 243 may be generated in accordance with compliance mapping system 230. In some embodiments, tree structures may be formatted in accordance with a specific structure which facilitates unique identification of every node and version of which has existed within the system. Compliance mapping system 230 may further provide a means for mapping tree structures 242, 243 to controls 245, as well as for mapping compliance evidence 275 to controls 245, and for mapping tree structures 242, 243 to one another. An example of such a structure is described in co-pending U.S. Provisional Patent Application No. 63/591,549, filed on Oct. 19, 2023, Attorney Docket Number 05007268-339USPR, the entire contents of which are incorporated herein by reference.

Controls may be used as the tool for automatic collection of compliance evidence 275 from applications on a continuous basis. For example, if a change is made to an application, this may trigger a control, which would result in an event generated by the operating environment. A stream of such events together with compliance evidence 275 from the triggered controls may be published and received from each application running on a particular public cloud. In some embodiments, such events may be processed by downstream systems configured to process events.

As depicted in FIG. 4, system 126 includes anomaly detection system 250 and prediction engine 260. Anomaly detection system 250 may be a layered system in which there are separate processing subsystems: a first subsystem for handling real-time processing, and a second subsystem which is decoupled from the first subsystem which handles the generation and maintenance of anomaly detection machine learning models. Since the two subsystems are de-coupled, anomaly detection system 250 may be capable of performing real-time anomaly detection using anomaly detecting ML models which are run in parallel and which are continuously updated and refined by the second processing subsystem. A detailed example implementation of a layered anomaly detection system is described in co-pending U.S. Provisional Patent No. 63/591,566, filed on Oct. 19, 2023, Attorney Docket Number 05007268-344USPR, the entire contents of which are incorporated herein by reference.

Prediction engine 260 may provide compliance and risk prediction based on compliance evidence 275 which is incomplete. For example, if a given control 245 relates to 5 separate attributes and compliance evidence 275 data contains data relating to only 3 of the 5 attributes, this may result in anomalous behaviour by the system and trigger flags which may be unnecessary and/or inaccurate, as the absence of certain values or attributes in the data may be unexpected. Prediction engine 260 may be configured to use a combination of historical compliance data and machine learning techniques to generate predicted compliance evidence data which supplements the received compliance evidence data to form a more complete set. In so doing, the system is less likely to raise false alarms, as there is a lower likelihood of alerts being generated solely based on missing or incomplete data. A detailed example implementation of a compliance and risk prediction system is described in co-pending U.S. Provisional Patent No. 63/591,560, filed on Oct. 19, 2023, Attorney Docket Number 05007268-343USPR, the entire contents of which are incorporated herein by reference.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A system for automated compliance monitoring and risk detection for applications executing in a distributed operating environment, the system comprising:
an automated mapping and tree structure generation module configured to automatically convert rule-containing documents to tree data structures comprising nodes representing compliance rules;
a compliance mapping system configured to separate technical and domain expertise and provide mappings between said tree data structures, controls which monitor applications for compliance with compliance rules, and generate compliance evidence when an event triggers the control;
a layered anomaly detection system configured to detect anomalous behaviour from said application, said anomaly detection system comprising a real-time processing component and a second processing component de-coupled from said real-time processing component, said second processing component configured to generate and refine anomaly detection machine learning models, said real-time processing component configured to detect anomalous behavior in real-time using said anomaly detection machine learning models; and
a compliance and risk prediction system configured to account for partial compliance evidence by generating predicted partial compliance evidence data for missing components of said compliance controls.

2. The system of claim 1, wherein the distributed operating environment is a public cloud.

3. The system of claim 1, wherein the distributed operating environment is a private cloud.

4. The system of claim 1, wherein the application is a Software-as-a-Service (SaaS) application.

5. The system of claim 1, wherein said mapping and tree generation module is further configured to automatically update said tree data structures when any of said underlying rule-containing documents are modified.

6. The system of claim 1, wherein said rule-containing documents comprise at least one of regulatory documents, policy documents, technical standards documents, compliance documents, and/or risk documents.

7. The system of claim 1, wherein said compliance mapping system is further configured to generate a compliance score based on said compliance evidence and said control.

8. The system of claim 1, further comprising adjusting parameters of one or more of said layered anomaly detection system and/or said compliance and risk prediction system based on outputs of said system.

9. A method of compliance monitoring and risk detection for applications executing in a distributed operating environment, the method comprising:
converting rule-containing documents to tree data structures comprising nodes representing compliance rules;
providing mappings between said tree data structures;
providing controls which monitor applications for compliance with compliance rules;
generating compliance evidence when an event triggers at least one of said controls;
detecting anomalous behaviour from said application using a real-time processing component and a second processing component de-coupled from said real-time processing component; and
generating predicted partial compliance evidence data for missing components of said compliance controls.

10. The method of claim 9, further comprising automatically updating said tree data structures when any of said rule-containing documents are modified.

11. The method of claim 9, wherein said second processing component is configured to generate and refine anomaly detection machine learning models.

12. The method of claim 11, wherein said real-time processing component is configured to detect anomalous behaviour in real-time using said anomaly detection machine learning models.

13. The method of claim 9, wherein said rule-containing documents comprise at least one of regulatory documents, policy documents, technical standards documents, compliance documents, and/or risk documents.

14. The method of claim 9, further comprising generating a compliance score based on said compliance evidence and said control.

15. The system of claim 9, further comprising adjusting parameters of one or more of said layered anomaly detection system and/or said compliance and risk prediction system based on outputs of said system.

16. A non-transitory computer-readable storage medium having stored thereon processor-executable instructions that, when executed by one or more processors, cause the one or more processors to perform a method comprising:
converting rule-containing documents to tree data structures comprising nodes representing compliance rules;
providing mappings between said tree data structures;
providing controls which monitor applications for compliance with compliance rules;
generating compliance evidence when an event triggers at least one of said controls;
detecting anomalous behaviour from said application using a real-time processing component and a second processing component de-coupled from said real-time processing component; and
generating predicted partial compliance evidence data for missing components of said compliance controls.

17. The non-transitory computer-readable storage medium of claim 16, further comprising automatically updating said tree data structures when any of said rule-containing documents are modified.

18. The non-transitory computer-readable storage medium of claim 16, wherein said second processing component is configured to generate and refine anomaly detection machine learning models.

19. The non-transitory computer-readable storage medium of claim 18, wherein said real-time processing component is configured to detect anomalous behaviour in real-time using said anomaly detection machine learning models.
